(19) United States
(12) Patent Application Publication
(10) Pub. No.: US 2010/0195466 A1
(43) Pub. Date: Aug. 5, 2010

(54) ELECTRONIC DEVICE, DATA RECORDING METHOD AND DATA RECORDING SYSTEM

(75) Inventors: Masafumi NOSAKA, Osaka (JP); Kenji TAKAUCHI, Osaka (JP); Ippei TATE, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/693,078

(22) Filed: Jan. 25, 2010

(30) Foreign Application Priority Data
Jan. 26, 2009 (JP) 2009-014003

(51) Int. Cl. G11B 7/28

(52) U.S. Cl. 369/84; G9B/7.2

(57) ABSTRACT

Data to be recorded onto a recording medium 220 is transmitted from an electronic device 100 toward an external recording drive 200 equipped with the recording medium 220 including a data region for recording data and an alternative region for recording the data to be written instead of the data region in the case of failure to write the data in the data region. The electronic device 100 acquires information on the used size of the alternative region from the external recording drive 200. In accordance with the information on the used size, the data transmission from the electronic device 100 toward the external recording drive 200 is inhibited.

### BACKGROUND OF THE INVENTION

1. Field of the Invention

The present invention relates to an electronic device having a function of transmitting data toward an external recording device for the purpose of recording (copying) data onto a recording medium in the external recording device. The present invention particularly relates to control in the case of the presence of an unrecordable region on the recording medium.

2. Description of Related Art

In order to record image data stored in an imaging device, such as a video camera, onto a recording medium, such as DVD (Digital Versatile Disc), the imaging device is connected to an external recording device generally via an interface, such as USB (Universal Serial Bus). Image data can be recorded on DVD in the external recording device by transmitting the image data from the imaging device toward the external recording device.

Meanwhile, recording media such as DVD are sensitive to foreign matters such as dust, fingerprints, and scratches. Therefore, if a foreign matter adheres on the surface of such a recording medium, writing of data in the region with such a foreign matter may be disabled. In order to continue writing the data even if the region with the foreign matter is present, the following process is known to those skilled in the art. That is, if a foreign matter is detected in the course of writing, data is not written in the region with the foreign matter, but data is written in an alternative region that has been prepared in advance and is physically quite different from the original region. After data of a predetermined size has been written in the alternative region, writing in a normal region is restarted, avoiding writing in the region with the foreign matter.

However, in the case where foreign matters are present in a number of regions, the alternative region may be depleted in the course of the recording. In this case, the recording is not completed in a normal manner, thereby failing to ensure the consistency of the recording contents and to reproduce the entire data on the recording medium. When the recording is not completed in a normal manner, generally, management information that is necessary for the reproduction and the next recording also cannot be created properly. As a result, although data is recorded physically, the reproduction of the data is impossible. Further, since the alternative regions have been depleted, it also is impossible to record new data.

In order to avoid such a problem, JP 7 (1995)-254229 A discloses a disk device configured to prevent an alternative region on a recording medium from being depleted. When the format of a disk (recording medium) is processed or the information recording instruction from a host computer is received, a CPU counts the number of alternate sectors for every region of the user region of a recording surface by using a defective sector-number control table of the disk. When the counted number of the alternate sectors exceeds a predetermined specified number alpha, the inhibited region of a group, to which the region belongs, is set as the record/erase inhibit region for information by turning ON a setting flag. Then, the inhibited region information is recorded in the unused sector of the DMA region (disk management region) of the disk, thereby preventing the alternative region in the disk from being depleted.

### SUMMARY OF THE INVENTION

According to the disk device described in JP 7 (1995)-254229 A, the disk device itself recognizes the state of the recording medium and sets a specific region as a recording/erasing inhibition region. Thus, the writing in the alternative region is reduced. As a result, the alternative region is prevented from being depleted. However, in the case of issuing a command to write data from the external to a recording device that does not have such a function, it is impossible to issue a command to designate a specific region including the alternative region on the recording medium in the data writing, or a command to inhibit the data writing. As a result, the alternative region on the recording medium is depleted, which may render the reproduction of the entire data on the recording medium impossible.

It is an object of the present invention to provide a novel technique for preventing an alternative region on a recording medium from being depleted and thus preventing the entire data on the recording medium from being rendered unreproducible.

That is, the present invention provides an electronic device including: a transmitter capable of transmitting data to be recorded onto a recording medium toward an external recording device equipped with the recording medium including a data region for recording data and an alternative region for recording the data intended to be written instead of the data region in the case of failure to write the data in the data region; an acquisitor configured to acquire information on a used size of the alternative region from the external recording device; and a transmission inhibition section configured to inhibit the transmission of the data toward the external recording device by the transmitter in accordance with the information on the used size acquired by the acquisitor.

According to another aspect of the present invention, there is provided a data recording method including the steps of transmitting data to be recorded onto a recording medium from an electronic device toward an external recording device equipped with the recording medium including a data region for recording data and an alternative region for recording the data intended to be written instead of the data region in the case of failure to write the data in the data region; transmitting information on a used size of the alternative region from the external recording device toward the electronic device; and inhibiting the transmission of the data from the electronic device toward the external recording device in accordance with the information on the used size.

Further, according to still another aspect of the present invention, there is provided a data recording system including: an external recording device equipped with a recording medium including a data region for recording data and an alternative region for recording the data intended to be written instead of the data region in the case of failure to write the data in the data region; and an electronic device capable of communicating with the external recording device. In the data recording system, the electronic device includes (i) a transmitter capable of transmitting data to be recorded onto the recording medium toward the external recording device, (ii) an acquisitor configured to acquire information on a used size of the alternative region from the external recording device, and (iii) a transmission inhibition section configured to inhibit the transmission of the data toward the external recording device by the transmitter in accordance with the information on the used size acquired by the acquisitor.

According to the present invention, the information on the used size of the alternative region is transmitted from the external recording device toward the electronic device. Then, the data transmission from the electronic device toward the external recording device is inhibited in accordance with the information on the used size. In this way, in recording data onto the recording medium in the external recording device, it is possible to prevent the alternative region of the recording medium from being depleted in the course of the recording as well as to avoid the situation where the reproduction of the data on the recording medium is rendered impossible.

### BRIEF DESCRIPTION OF THE DRAWINGS

FIG. 1 is a block diagram indicating a configuration of a data recording system according to one embodiment of the present invention.

FIG. 2 is a flowchart indicating a control to be performed in an electronic device according to one embodiment of the present invention.

FIG. 3 is a view illustrating an alternative region of a recording medium.

FIG. 4A is a view illustrating a display example of a display before the start of recording.

FIG. 4B is a view illustrating a display example of the display in the course of the recording.

FIG. 4C is a view illustrating a display example of the display at the time of the end of the recording.

FIG. 4D is a view illustrating a display example of the display at the time of the interruption of the recording.

### DETAILED DESCRIPTION OF THE INVENTION

Hereinafter, one embodiment of the present invention is described in detail with reference to the drawings.

### Embodiment 1

### 1-1. Configuration

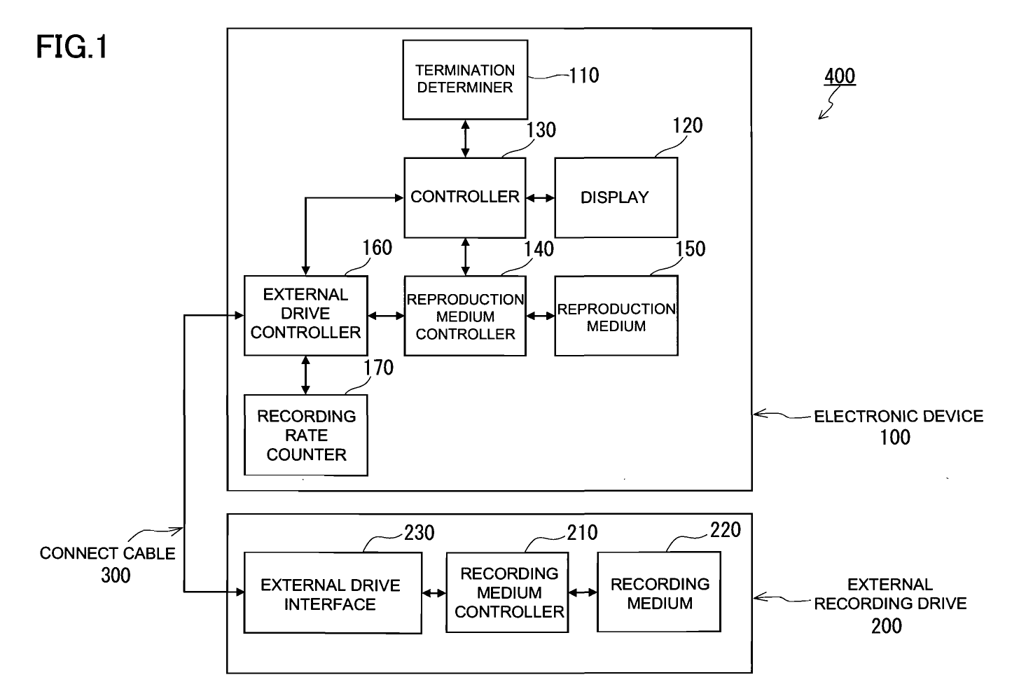

As indicated in FIG. 1, a data recording system 400 in Embodiment 1 of the present invention has an electronic device 100 and an external recording drive 200. The electronic device 100 and the external recording drive 200 are connected for communication by a connect cable 300. The electronic device 100 is typically an imaging device such as a digital video camera and a digital still camera, and it functions to record (copy) data that has been stored on an embedded or removable reproduction medium 150 onto a recording medium 220 in the external recording drive 200. The external recording drive 200 is typically a DVD recording device, a BD (Blu-ray Disc) recording device, a memory card writer, a hard disk recording device or the like, and it records the data transmitted from the electronic device 100 onto the recording medium 220 with a high capacity. Examples of the type of the data to be recorded include image data, audio data, and AV data (Audio Video data).

The electronic device 100 includes a controller 130, a termination determiner 110, a display 120, the reproduction medium 150, a reproduction medium controller 140, an external drive controller 160, and a recording rate counter 170. The controller 130 performs overall control of the electronic device 100. The termination determiner 110 determines whether or not to terminate the writing into the external recording drive 200. The display 120 presents various information to a user. The reproduction medium 150 holds data to be recorded. The reproduction medium controller 140 controls the read-out of the data from the reproduction medium 150. The external drive controller 160 controls the transmission of the data toward the external recording drive 200. The recording rate counter 170 calculates a recording rate based on the data transmission rate in the external drive controller 160.

The controller 130 may be constituted only by hardware, or may be constituted by the combination of hardware and software. The controller 130 can be achieved typically by a DSP (Digital Signal Processor) or a micro computer.

The termination determiner 110 determines whether or not to terminate the data writing into the external recording drive 200 based on a used size of an alternative region on the recording medium 220 in the external recording drive 200, which has been acquired using the external drive controller 160. The termination determiner 110 can be achieved by software. Although an embodiment provided with the termination determiner 110 separately from the controller 130 is described herein as Embodiment 1, the termination determiner 110 may be embodied also by the controller 130.

The display 120 displays images based on the data on the reproduction medium 150, messages to the user, and the like. The display 120 can be achieved by a liquid crystal monitor, for example. The display 120 may be a touch screen for operating the electronic device 100, or it may be an output interface for outputting data to an external monitor.

The reproduction medium 150 holds various data such as image data, audio data, and AV data. The reproduction medium 150 may be embedded in the electronic device 100, or it may be removable therefrom. The reproduction medium 150 is, for example, a semiconductor memory, a hard disk, DVD or BD.

The reproduction medium controller 140 is provided depending on the type of the reproduction medium 150, and it controls the read-out of the data from the reproduction medium 150.

The external drive controller 160 controls the communication between the electronic device 100 and the external recording drive 200. Examples of the connection configuration between the electronic device 100 and the external recording drive 200 include communication standards such as USB, IEEE 1394 (Institute of Electrical and Electronics Engineers), and LAN (Local Area Network). Although an embodiment in which the electronic device 100 and the external recording drive 200 are connected by the connect cable 300 is described herein as Embodiment 1, wireless communications such as Wi-Fi (Wireless Fidelity), and infrared radiation may be used therefor.

The recording rate counter 170 measures the data transmission rate in the external drive controller 160, and it calculates the recording rate of the external recording drive 200 onto the recording medium 220 based on the measured transmission rate. Although an embodiment provided with the recording rate counter 170 separately from the controller 130 is described herein as Embodiment 1, the recording rate counter 170 may be embodied by the controller 130.

The external recording drive 200 includes the recording medium 220, a recording medium controller 210 and an external drive interface 230. The data transmitted from the electronic device 100 toward the external recording drive 200 is recorded onto the recording medium 220. The recording medium controller 210 controls the data writing onto the recording medium 220. The external drive interface 230 controls the data communication between the external recording drive 200 and the electronic device 100.

The external drive interface 230 corresponds to the communication interface that corresponds to the connection configuration between the external recording drive 200 and the electronic device 100, and it controls the communication between the external recording drive 200 and the electronic device 100.

The recording medium 220 records the data transmitted from the electronic device 100 toward the external recording drive 200. The recording medium 220 may be embedded in the external recording drive 200, or may be removable therefrom. The recording medium 220 is a semiconductor memory, a hard disk, DVD or BD, for example.

The recording medium controller 210 is provided depending on the type of the recording medium 220, and it controls the data writing onto the recording medium 220.

### 1-2. Correspondence Relationship with Configuration of the Present Invention

The external drive controller 160 is an example of a transmitter capable of transmitting data toward the external recording drive 200. The external drive controller 160, the controller 130 and the recording rate counter 170 are an example of an acquisitor for acquiring information from the external recording drive 200. The termination determiner 110 and the controller 130 are an example of a transmission inhibition section for inhibiting the transmission of the data by a transmitter (the external drive controller 160) toward the external recording drive 200. The controller 130 is an example of a display controller for controlling the display 120. The external drive controller 160 and the controller 130 are an example of a management information acquisitor for acquiring management information recorded on the recording medium 220. The controller 130 is also an example of a recovery section for recovering the recording medium 220 using the management information.

### 2. Operation of Electronic Device

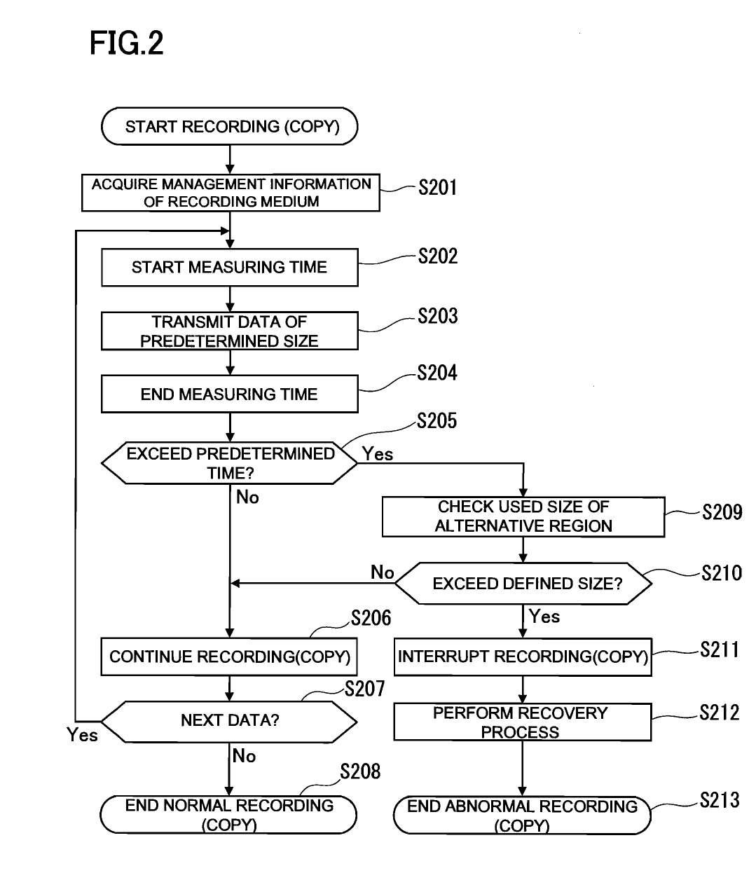

The operation of the electronic device 100 at the time of the data writing onto the recording medium 220 in the external recording drive 200 is described with reference to the flowchart of FIG. 2.

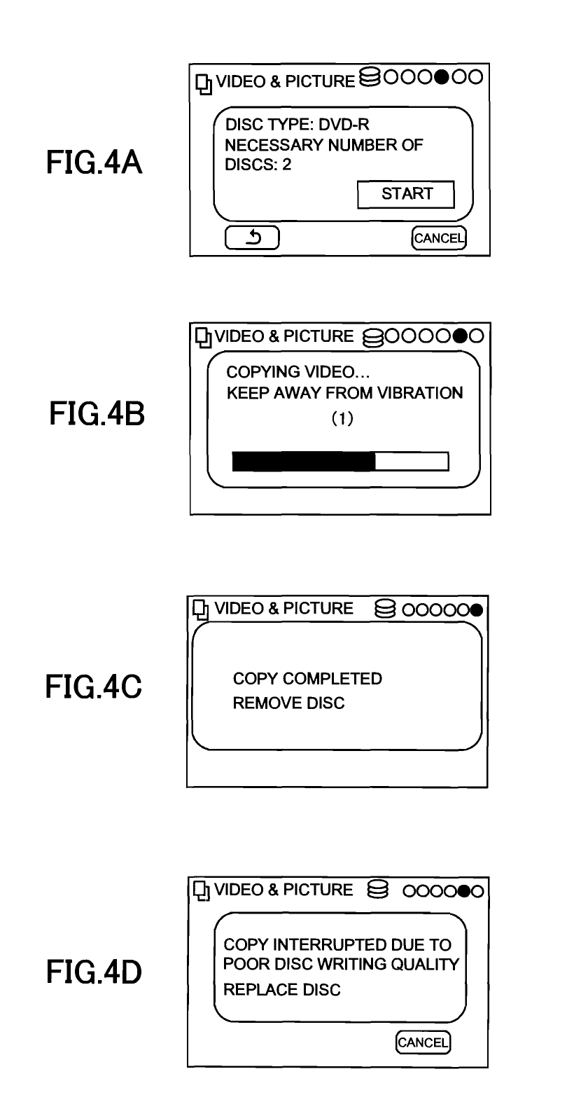

Upon the selection of the recording start in the operation menu by a user, the controller 130 performs control for displaying the guidance information indicated in FIG. 4A on the display 120. On the screen in FIG. 4A, the user selects “start”, and the electronic device 100 starts a process for recording the data stored in the reproduction medium 150 onto the recording medium 220 in the external recording drive 200.

The controller 130 acquires the management information present on the recording medium 220 by querying the external drive controller 160 (S201). This is because the controller 130 uses, at the time of the after-mentioned recovery process, the management information before the start of the recording. In the case where the recording is completed in a normal manner, new management information is created to update the management information before the start of the recording, and the new management information is written onto the recording medium 220.

The detailed contents of the management information differ from the application format and file system. For example, AVCHD (Advanced Video Codec High Definition (registered trademark)) is known as an application format. As a file system, for example, FAT32 (File Allocation Table 32) file system, LTDF (Universal Disk Format) and the like are known. Generally, the management information includes information for specifying the format of the data recorded on the recording medium 220, the number of the recorded data (files), the data reproducing method, the playlists of the data and the like. Such management information is updated every time new data is written onto the recording medium 220. That is, at the time of starting the writing of new data onto the recording medium 220, prior the management information is erased once from the recording medium 220, and after the completion of the data writing, new management information is written onto the recording medium 220. If the alternative region is depleted in the course of the data writing and the further recording of the data is rendered impossible, the management information also is lost. As a result, neither recording nor reproduction is possible.

The recording rate counter 170 starts measuring time (S202) upon the start of the transmission of the data from the external drive controller 160 toward the external recording drive 200. When completing the transmission of the data of a predetermined size (S203), it stops measuring time (S204). That is, the data is divided into the predetermined size and transmitted toward the external recording drive 200 in Embodiment 1. The size of the data to be transmitted in a single process is, for example, several hundred KB to several MB. The transmission of the data of the predetermined size takes, for example, several hundred milliseconds, although this is not always appropriate since it depends on the performance of the electronic device 100, the performance of the external recording drive 200, the standard of the connect cable 300 and the like.

The controller 130 acquires, from the recording rate counter 170, the time required to transmit the data of the predetermined size and it determines whether or not the time required to transmit the data exceeds a predetermined time period (S205). If the time required to transmit the data exceeds the predetermined time period (YES in S205), the controller 130 acquires and checks the used size of the alternative region on the recording medium 220 in the external recording drive 200 via the external drive controller 160 (S209). The “used size” means the size of the data that has been recorded currently in the alternative region. It should be noted that the time required to transmit the data of the predetermined size is substantially the same as the time required to write the data of the predetermined size onto the recording medium 220.

On the other hand, if the time required to transmit the data is equal to or less than the predetermined time period (NO in S205), the controller 130 continues the recording (S206) and further determines the presence or absence of the next data (S207). That is, it determines whether or not the data to be transmitted still remains. If the next data is present (YES in S207), the transmission of the data and the measurement of the time required to transmit the data are continued (S202 to S204). The controller 130 performs control for displaying the guidance information indicated in FIG. 4B on the display 120 during the continuation of the data transmission. The controller 130 performs control for displaying the guidance information indicated in FIG. 4C on the display 120 at the time of the completion of the data transmission (NO in S207). Furthermore, new management information is created in the controller 130 using the management information that has been acquired in advance, and the thus created new management information is transmitted toward the external recording drive 200. Thus, a normal recording process ends (S208). The management information transmitted toward the external recording drive 200 is written onto the recording medium 220.

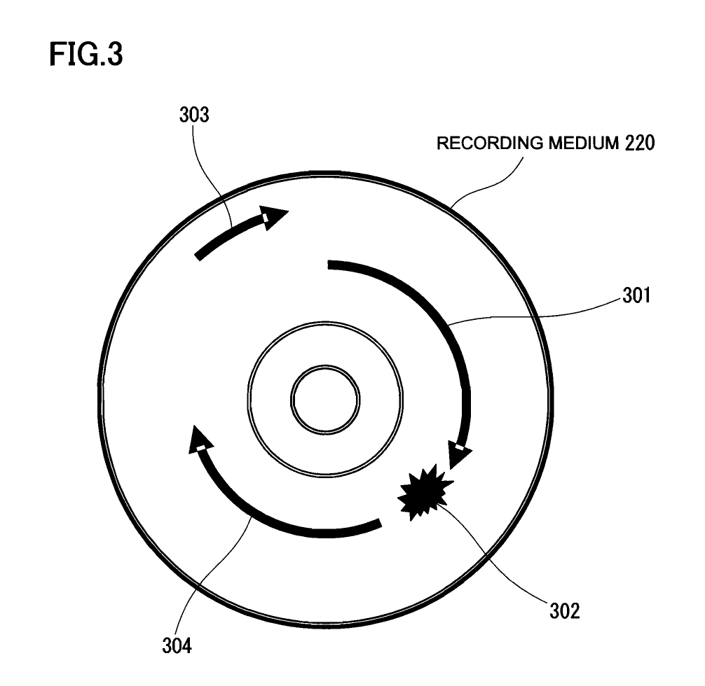

Here, the operational difference between the cases of the data region and the alternative region on the recording medium 220 in which the external recording drive 200 records the data is described with reference to FIG. 3.

The external recording drive 200 defines a data region to record data and an alternative region at a position physically different from the data region on the recording medium 220 at the time of the start of the recording onto the recording medium 220 in advance. Here, the alternative region means the region to record the data, when the writing in the data region is impossible, instead of the data region. The size of the alternative region is set, for example, to about 1 to 5% of the total capacity of the recording medium 220. In the example of FIG. 3, the alternative region is defined in a comparatively outer region. The position of the alternative region is not specifically limited. A plurality of regions may be defined as alternative regions. In FIG. 3, if a foreign matter such as dust, fingerprint and scratch is detected (referential numeral 302) in the course of writing onto the recording medium 220 (referential numeral 301), the writing is performed in the alternative region (referential numeral 303) that has been prepared in advance. After writing the data of a specific size in the alternative region, the writing in the data region is restarted from the vicinity of the region where the foreign matter has been detected (referential numeral 304).

In this way, in the case where the external recording drive 200 records the data in the alternative region on the recording medium 220, the data is written in a physically different region, and therefore the time for the writing increases compared to the normal writing in the data region. For example, supposing that the recording medium 220 is DVD or BD, it takes a comparatively long time to move the optical pickup. Generally, since the one-way data transmission from the electronic device 100 toward the external recording drive 200 is impossible, when time is taken for writing, time is taken also for the data transmission from the electronic device 100 toward the external recording drive 200. The time for writing data in the alternative region is, for example, 4 to 10 times as much as the time for writing the data in the data region. Accordingly, the controller 130 can determine whether or not the writing in the alternative region has occurred in the external recording drive 200 by measuring the time required to transmit the data (S205). Such an increase in the time for transmitting the data can occur due to factors other than the writing in the alternative region. Therefore, the controller 130 acquires the used size of the alternative region if the time for transmitting the data exceeds the predetermined time period (S209), which makes it possible to recognize the state of the writing in the alternative region accurately.

Further, the controller 130 acquires the used size of the alternative region only if the time required to transmit the data exceeds the predetermined time period (S209). Therefore, it is possible to prevent the data transmission from being interrupted frequently due to the frequent acquisition of the used size of the alternative region, thus preventing an increase in the time required for the data transmission.

The termination determiner 110 is notified of the used size of the alternative region on the recording medium 220 by the controller 130. If the used size exceeds the defined size determined in advance (YES in S210), the termination determiner 110 determines that the data transmission is to be interrupted and notifies the controller 130 of the result. On the other hand, if the used size is equal to or less than the defined size determined in advance (NO in S210), the termination determiner 110 determines that the data transmission is to be continued and notifies the controller 130 of the result. In the case of the presence of the next data (YES in S207), the controller 130 repeats the transmission of the data of the predetermined size and the measurement of the time required to transmit the data of the predetermined size (S202 to S204).

Thus, according to this Embodiment 1, the determination of whether or not the used size of the alternative region exceeds the defined size is made, and in accordance with the result thereof, the determination on whether the data transmission is to be continued or the data transmission is to be interrupted is made. In the case where the used size of the alternative region on the recording medium 220 exceeds the defined size, the depletion of the alternative region on the recording medium 220 can be prevented by interrupting the transmission and writing of data. As a result, it is possible to avoid the situation where the consistency of the recording contents cannot be ensured, the recording is interrupted, and thus the reproduction of the entire data on the recording medium 220 is rendered impossible.

Upon the reception of the notification from the termination determiner 110 indicating that the transmission is to be interrupted, the controller 130 interrupts the data transmission toward the external recording drive 200 using the external drive controller 160 and performs control for displaying the message of the interruption on the display 120 as indicated in FIG. 4D (S211). In this way, the user can recognize the failure to copy data by the message displayed on the display 120 indicating that the recording (copying) did not end in a normal manner. Further improvement in convenience can be expected by performing control for displaying, on the display, a message for urging the user to replace the recording medium 220 in the external recording drive 200.

In the case where the data transmission is interrupted, the controller 130 writes, onto the recording medium 220, the management information that has been acquired in advance in the step S201 before the start of the recording (S212) in order to restore the recording medium 220 as it was before the start of the data writing. Thereafter, the controller 130 ends the process (S213). This is for the purpose of avoiding the situation where the interruption of the data writing onto the recording medium 220 causes inconsistency of the management information of the recording medium 220 to occur, thereby rendering the reproduction of the entire data that has been recorded onto the recording medium 220 impossible. By restoring the management information of the recording medium 220 as it was before the start of the data writing, although the reproduction of the data recorded from the start of the data writing to the interruption of the writing is impossible, the data that had been recorded before then can be reproduced properly.

As described above, in Embodiment 1, when the used size of the alternative region exceeds a defined size, the data transmission toward the external recording drive 200 is inhibited. This makes it possible to prevent the alternative region from being depleted without fail. For example, supposing that the recording medium 220 has a capacity of 50 GB and its alternative region has a capacity of 2 GB, 50% of the capacity of the alternative region, that is, 1 GB can be set as a “defined size”. It should be noted that the defined size is not necessarily 50% of the capacity of the alternative region. For example, the defined size may be 60%, or may be 40%. In short, the defined size may have any capacity.

Further, according to Embodiment 1, when the time required to transmit the data (transmission time) exceeds the predetermined time period, information on the used size of the alternative region is acquired from the external recording drive 200. This can eliminate the frequent need to interrupt the data transmission, so that rapid recording (copy) can be achieved. It should be noted that the “information on the used size” means sufficient information for specifying the used size of the alternative region. For example, the used size can be specified from the total capacity and unused size of the alternative region.

Further, according to Embodiment 1, the management information recorded on the recording medium 220 in the external recording drive 200 is transferred to the electronic device 100 before the data transmission from the electronic device 100 toward the external recording drive 200. The electronic device 100 stores the acquired management information in its memory until the completion of the data transmission. Then, in the case where the used size of the alternative region exceeds the defined size before the completion of the data transmission, a recovery process for the recording medium 220 is performed using the management information that has been transferred to the electronic device 100 in advance. Specifically, the management information is transmitted from the electronic device 100 toward the external recording drive 200 and a command indicating that the management information is to be recorded onto the recording medium 220 is issued from the electronic device 100 to the external recording drive 200, so that the management information that has been stored in advance in the electronic device 100 is re-recorded onto the recording medium 220 and thereby the recording medium 220 is rendered reproducible. The external recording drive 200 writes the acquired management information onto the recording medium 220. Thus, it is possible to protect the data that had been stored on the recording medium 220 before the start of the recording without fail.

Further, according to Embodiment 1, the data to be recorded onto the recording medium 220 is divided into the predetermined size and transmitted toward the external recording drive 200. Then, only if the time required to transmit the data of the predetermined size (transmission time) exceeds the predetermined time period, information on the used size of the alternative region is acquired from the external recording drive 200. On the other hand, if the transmission time is within the predetermined time period, the process of acquiring the information on the used size of the alternative region is not carried out, and the process of transmitting the next data of the predetermined size is carried out. More specifically, if the time required to transmit the data of the predetermined size (transmission time) exceeds the predetermined time period as well as the used size exceeds the defined size, the data transmission toward the external recording drive 200 is inhibited. If the transmission time exceeds the predetermined time period but the used size of the alternative region is within the defined size, the process of transmitting the next data of the predetermined size is carried out. This can eliminate the frequent need to interrupt the data transmission, so that rapid recording (copy) can be achieved.

### Other Embodiments

Embodiment 1 has been described hereinabove as one embodiment of the present invention. However, the present invention is not limited thereto. Therefore, other embodiments of the present invention are described collectively herein.

In Embodiment 1, the controller 130 acquires the used size of the alternative region on the recording medium 220 when the time required to transmit the data of the predetermined size exceeds the predetermined time period. However, it also may be possible to acquire the used size of the alternative region before the start of the recording. That is, the information on the used size of the alternative region is acquired from the external recording drive 200 before the data transmission toward the external recording drive 200. Thus, the controller 130 can recognize the used size of the alternative region on the recording medium 220 before the start of the recording. If the used size of the alternative region exceeds the defined size, the data transmission toward the external recording drive 200 is inhibited and the data writing onto the recording medium 220 is not performed. In this way, it is possible to avoid the situation where the alternative region of the recording medium 220 is depleted, the recording is interrupted without ensuring the consistency of the recording contents, and thus the reproduction of the entire data in the recording medium 220 is rendered impossible.

Further, in Embodiment 1, the management information is saved in the electronic device 100 in advance. However, it also is possible to newly create management information in the recovery process of the step S212 in FIG. 2, and to record the created management information onto the recording medium 220. In this case, it is possible to reproduce the data that had been recorded on the recording medium 220 from the start of the recording to the interruption of the recording.

According to the present invention, when recording data onto a recording medium in an external recording device, it is possible to avoid the situation where an alternative region of the recording medium is depleted in the course of the recording, and the reproduction of the recording medium is rendered impossible. Therefore, the present invention can be applied advantageously to imaging devices such as a video camera and a digital still camera.

The present invention may be embodied in other forms without departing from the spirit or essential characteristics thereof. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An electronic device comprising:
a transmitter capable of transmitting data to be recorded onto a recording medium toward an external recording device equipped with the recording medium including a data region for recording data and an alternative region for recording the data intended to be written instead of the data region in the case of failure to write the data in the data region;
an acquisitor configured to acquire information on a used size of the alternative region from the external recording device; and
a transmission inhibition section configured to inhibit the transmission of the data toward the external recording device by the transmitter in accordance with the information on the used size acquired by the acquisitor.

2. The electronic device according to claim 1, wherein
the transmission inhibition section inhibits the transmission of the data toward the external recording device by the transmitter if the used size exceeds a defined size.

3. The electronic device according to claim 1, wherein
the acquisitor acquires the information on the used size from the external recording device if a transmission time of the data by the transmitter exceeds a predetermined time period.

4. The electronic device according to claim 1, further comprising:
a display configured to display information; and
a display controller configured to perform control for displaying, on the display, a message for urging replacement of the recording medium in the external recording device if the used size exceeds a defined size.

5. The electronic device according to claim 1, wherein
the acquisitor acquires the information on the used size from the external recording device before the transmission of the data by the transmitter, and
the transmission inhibition section inhibits the transmission of the data toward the external recording device by the transmitter if the used size exceeds a defined size.

6. The electronic device according to claim 1, further comprising:
a management information acquisitor configured to acquire management information recorded onto the recording medium in the external recording device before the transmission of the data by the transmitter; and
a recovery section configured to recover the recording medium by means of the management information if the used size exceeds a defined size before the completion of the transmission of the data by the transmitter.

7. The electronic device according to claim 6, wherein
the recovery section issues a command to the external recording device to record the management information onto the recording medium so that the recording medium is rendered reproducible by re-recording of the management information onto the recording medium.

8. The electronic device according to claim 1, wherein
the transmitter is configured to divide the data to be recorded onto the recording medium into a predetermined size and transmit the data toward the external recording device,
the acquisitor acquires the information on the used size from the external recording device only if a transmission time of the data of the predetermined size by the transmitter exceeds the predetermined time period, and
the acquisitor, on the other hand, does not acquire the information on the used size and the next data of the predetermined size is transmitted if the transmission time by the transmitter is within the predetermined time period.

9. The electronic device according to claim 8, further comprising:
a management information acquisitor configured to acquire management information recorded on the recording medium in the external recording device before the transmission of the data by the transmitter; and
a recovery section configured to recover the recording medium by means of the management information if the used size exceeds a defined size before the completion of the transmission of the data by the transmitter, wherein
the transmission inhibition section inhibits the transmission of the data toward the external recording device by the transmitter if the transmission time exceeds the predetermined time period as well as the used size exceeds the defined size, and
the transmitter, on the other hand, transmits the next data of the predetermined size if the transmission time exceeds the predetermined time period but the used size is within the defined size.

10. A data recording method comprising the steps of
transmitting data to be recorded onto a recording medium from an electronic device toward an external recording device equipped with the recording medium including a data region for recording data and an alternative region for recording the data intended to be written instead of the data region in the case of failure to write the data in the data region;
transmitting information on a used size of the alternative region from the external recording device toward the electronic device; and
inhibiting the transmission of the data from the electronic device toward the external recording device in accordance with the information on the used size.

11. A data recording system comprising:
an external recording device equipped with a recording medium including a data region for recording data and an alternative region for recording the data intended to be written instead of the data region in the case of failure to write the data in the data region; and
an electronic device capable of communicating with the external recording device, the electronic device including:
(i) a transmitter capable of transmitting data to be recorded onto the recording medium toward the external recording device;
(ii) an acquisitor configured to acquire information on a used size of the alternative region from the external recording device; and
(iii) a transmission inhibition section configured to inhibit the transmission of the data toward the external recording device by the transmitter in accordance with the information on the used size acquired by the acquisitor.
